(19) United States
(12) Patent Application Publication
(10) Pub. No.: US 2004/0175092 A1
(43) Pub. Date: Sep. 9, 2004

(54) Hermetically sealed optical amplifier module to be integrated into a pressure vessel for undersea applications

(76) Inventors: Mark K. Young, Monmouth Junction, NJ (US); David S. DeVincentis, Flanders, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/741,809

(22) Filed: Dec. 19, 2003

Related U.S. Application Data
(60) Provisional application No. 60/434,753, filed on Dec. 19, 2002.

(51) Int. Cl. G02B 6/44

(52) U.S. Cl. 385/138; 385/100

(57) ABSTRACT

The present invention provides a hermetically sealed module to be located in an external pressure vessel providing protection from external pressure in an undersea environment. The hermetically sealed module includes at least one optical amplifier and an hermetically sealed housing for containing the optical amplifier. The housing has a retaining element for retaining the housing within the external pressure vessel. The module also includes a plurality of ports for conveying into the housing, in an hermetically sealed manner, at least one optical fiber and a conductor incorporated in an undersea optical fiber cable. The conductor supplies electrical power to the optical amplifier. At least one conductive terminal is located in the housing for establishing electrical contact with the conductor traversing each of the plurality of ports. The conductive terminal supplies electrical power from the conductor to the optical amplifier.

### STATEMENT OF RELATED APPLICATION

This application claims the benefit of priority to U.S. Provisional Patent Application 60/434,753, filed Dec. 19, 2002, entitled “Hermetically Sealed Optical Amplifier Module To Be Integrated Into A Pressure Vessel For Undersea Applications.

### FIELD OF THE INVENTION

The present invention relates to the field of optical repeaters and more particularly to an optical repeater for use in an undersea optical communication system.

### BACKGROUND OF THE INVENTION

In undersea optical transmission systems optical signals that are transmitted through an optical fiber cable become attenuated over the length of the cable, which may span thousands of miles. To compensate for this signal attenuation, optical repeaters are strategically positioned along the length of the cable.

In a typical optical repeater, the optical fiber cable carrying the optical signal enters the repeater and is coupled through at least one amplifier and various components, such as optical couplers and decouplers, before exiting the repeater. These optical components are coupled to one another via optical fibers. Repeaters are housed in a sealed structure that protects the repeaters from environmental damage. During the process of deployment, the optical fiber cable is coiled onto large drums located on a ship. Consequently, the repeaters become wrapped about the drums along with the cable. Due to the nature of the signals, and the ever increasing amount of information being transmitted in the optical fibers, repeaters are getting larger, and their increased length creates problems as they are coiled around a drum. Although the drums may be up to 9-12 feet in diameter, current repeaters may be greater than 5 feet in length, and, therefore, are not able to lie flat, or even substantially flat, along a drum. Tremendous stresses due to forces on the order of up to 100,000 pounds are encountered at the connection point between the repeater and the fiber optic cable to which it is attached, especially during paying out and reeling in of the cable. The non equi-axial loading across the cable may arise as a result of severe local bending that is imposed on the cable at its termination with the repeater. This loading would inevitably lead to failure of cable components at loads well below the tensile strength of the cable itself.

To prevent failure of the cable during deployment of the repeater, a bend limiter is often provided, whose purpose is to equalize the forces imposed on the cable. In addition, a gimbal may be provided at each longitudinal end of the repeater to which the bend limiting devices are attached. The gimbal provides free angular movement in two directions. The bend angle allowed by the gimbal between the repeater and bend limiting device further reduces the local bending that is imposed on the optical fiber cables.

The large physical size of conventional repeaters increases their complexity and cost while creating difficulties in their deployment.

### SUMMARY OF THE INVENTION

The present invention provides a hermetically sealed module to be located in an external pressure vessel providing protection from external pressure in an undersea environment. The hermetically sealed module includes at least one optical amplifier and an hermetically sealed housing for containing the optical amplifier. The housing has a retaining element for retaining the housing within the external pressure vessel. The module also includes a plurality of ports for conveying into the housing, in an hermetically sealed manner, at least one optical fiber and a conductor incorporated in an undersea optical fiber cable. The conductor supplies electrical power to the optical amplifier. At least one conductive terminal is located in the housing for establishing electrical contact with the conductor traversing each of the plurality of ports. The conductive terminal supplies electrical power from the conductor to the optical amplifier.

In accordance with one aspect of the invention, a pressure seal is located between each of the ports and the conductor.

In accordance with another aspect of the invention, the pressure seal is a polyethylene seal.

In accordance with another aspect of the invention, the undersea optical fiber cable further includes an electrically insulating sheath surrounding the optical fiber and the conductor. The pressure seal is located between the port and the electrically insulating sheath.

In accordance with another aspect of the invention, the conductive terminal includes a through hole traversed by the optical fiber.

In accordance with another aspect of the invention, a ferrule is located in the through hole. The ferrule is traversed by the optical fiber and provides a hermetic seal therewith.

In accordance with another aspect of the invention, an end portion of the optical fiber includes a metallized coating for soldering the optical fiber within the housing.

In accordance with another aspect of the invention, the retaining element includes an adjustable expansion mechanism located on an outer surface of the housing for exerting pressure against an inner wall of the pressure vessel so that the housing is retained therein.

In accordance with another aspect of the invention, the adjustable expansion mechanism includes a plurality of pivotable members.

In accordance with another aspect of the invention, the adjustable expansion mechanism includes an alignment member for aligning the housing within the pressure vessel.

In accordance with another aspect of the invention, the alignment member is selected from the group consisting of a boss, tab, tang and slot.

In accordance with another aspect of the invention, the adjustable expansion mechanism provides continuous indexing variability.

In accordance with another aspect of the invention, a gas fill port extends into the housing for supplying gas to an interior of the housing.

In accordance with another aspect of the invention, a fiber tray is located in the housing for supporting optical fiber employed in the optical amplifier.

In accordance with another aspect of the invention, a plurality of receptacles are provided which are sized to receive a passive optical component employed in the optical amplifier.

In accordance with another aspect of the invention, the plurality of receptacles are integrally formed with said fiber tray.

In accordance with another aspect of the invention, the optical amplifier includes a circuit board located in the housing.

In accordance with another aspect of the invention, the optical amplifier includes at least one optically active element mounted to the circuit board. The optical amplifier comprises a rare-earth doped optical amplifier.

In accordance with another aspect of the invention, the rare-earth doped optical amplifier includes a rare-earth doped fiber for imparting gain to an optical signal propagating therethrough, a pump source for supplying pump power to the rare-earth doped fiber, and a coupler for coupling the pump power to the rare-earth doped fiber. The rare-earth doped fiber and the coupler each reside in one of the plurality of receptacles.

### BRIEF DESCRIPTION OF THE DRAWINGS

FIG. 1 shows an example of a pressure vessel that can be inserted in a fiber optic cable for use in undersea optical telecommunication systems.

FIG. 2 shows one embodiment of the optical amplifier module (OAM) constructed in accordance with the present invention after it has been assembled and sealed.

FIG. 3 shows the OAM depicted in FIG. 2 as it is situated within the pressure housing.

FIG. 4 shows the OAM of FIG. 2 with its outer cover removed.

FIG. 5 shows the feed-through arrangement for providing the conductor tube and the optical fibers into the OAM in an hermetically sealed manner.

FIG. 6 shows an end view of the OAM depicted in FIG. 2 as it is situated within the pressure housing.

FIG. 7 shows a cross-sectional view through both the OAM and the pressure housing.

### DETAILED DESCRIPTION

The present inventors have recognized that a substantially smaller repeater can be achieved by first reducing the length of the repeater so that the stresses placed upon it during its deployment are greatly reduced, thereby eliminating the need for gimbals. The elimination of the gimbals, in turn, allows further reductions in the dimensions of the repeaters.

The present inventors have further recognized that a repeater substantially reduced in size can be housed in a unit formed from off-the-shelf components that have been qualified for the undersea environment. The present invention thus provides a repeater that, because of its small size, is easily deployed and which is located in an economical, submarine qualified housing that is already well established in the undersea optical communications industry.

The present invention provides an optical amplifier module (OAM) for use in undersea optical communication systems. The OAM is designed to be located in a pressure vessel that is used to interconnect two fiber optic cables. The pressure vessel provides protection to the OAM from external sources of pressure and tension while the OAM provides a hermetic seal for the various components that are contained therein. One important advantage of the invention is that the OAM is a sealed device in which its operational details are not discernable, except through defined optical, electrical and mechanical interfaces. Thus, the party responsible for integrating the OAM within the pressure vessel only needs to connect it along these interfaces and the OAM will function to its design parameters. No other action needs to be taken by the integrator. In this way the OAMs, which generally contain complex electronic and optical components, can be built up as separate sub-assemblies from the mechanics of the pressure vessel, thereby providing more flexibility in manufacturing. Moreover, the integration between the pressure vessel and the OAM can take place in a different location from where the OAMs are manufactured, but since the OAM is a sealed functional unit, it can be transported and stocked without concern that its internal electronic and optical components will be damaged.

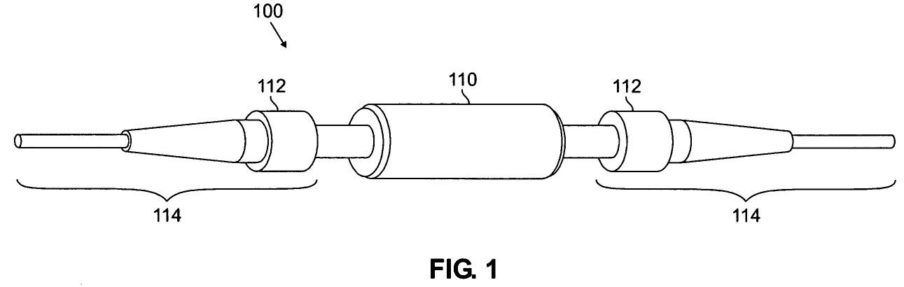

FIG. 1 shows an example of a pressure vessel 100 that can be inserted in a fiber optic cable for use in undersea optical telecommunication systems. The pressure vessel includes a pressure housing 110 and cable termination units 114. The cable termination units 114 provide mechanical, electrical and optical continuity to the outboard ends of the cable in which the pressure vessel is inserted. The cable termination units 114 each include a splice bottle 112 in which the fiber optic splice is located. The cable termination units 114 are bend limited to prevent cable damage. The pressure housing 110 primarily serves to protect the internal components from external pressure and is not necessarily hermetically sealed. One example of a pressure vessel 100 is available from NSW. The NSW pressure vessel is sometimes conventionally used to house a remote optically pumped amplifier (ROPA), in which the active components (e.g., the pump sources and associated electronics) are located on shore and only the passive optical components (e.g., the erbium doped fibers, coupler, and isolators) of the amplifier are located in the pressure vessel. That is, optical pump energy is provided to the pressure vessel from the shore so that the pressure vessel need not contain any components that require the provision of electrical energy. By contrast, in the present invention the entire optical amplifier, active and passive components included, are all located in the pressure vessel, thus requiring that electrical power be supplied to the pressure vessel.

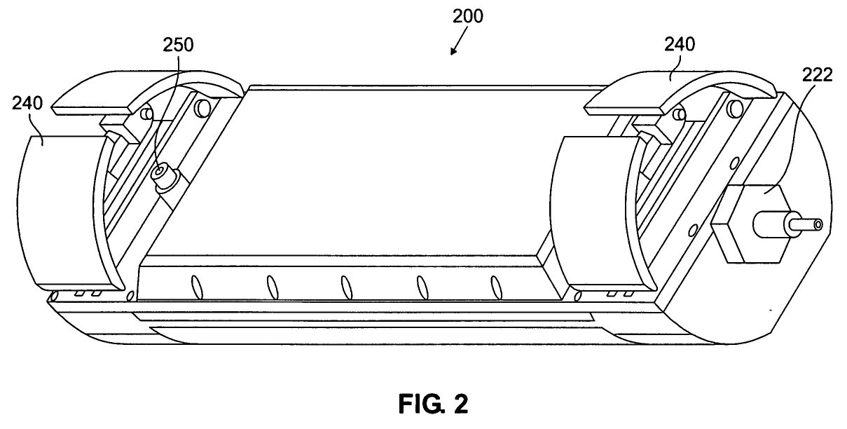

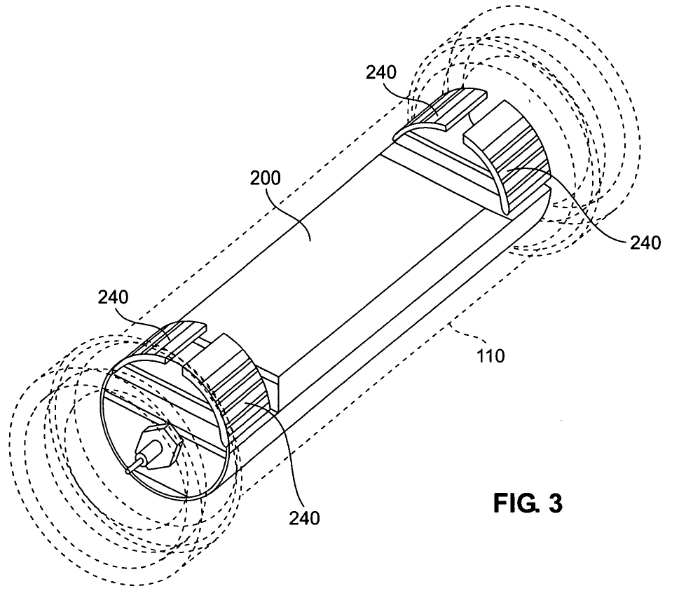

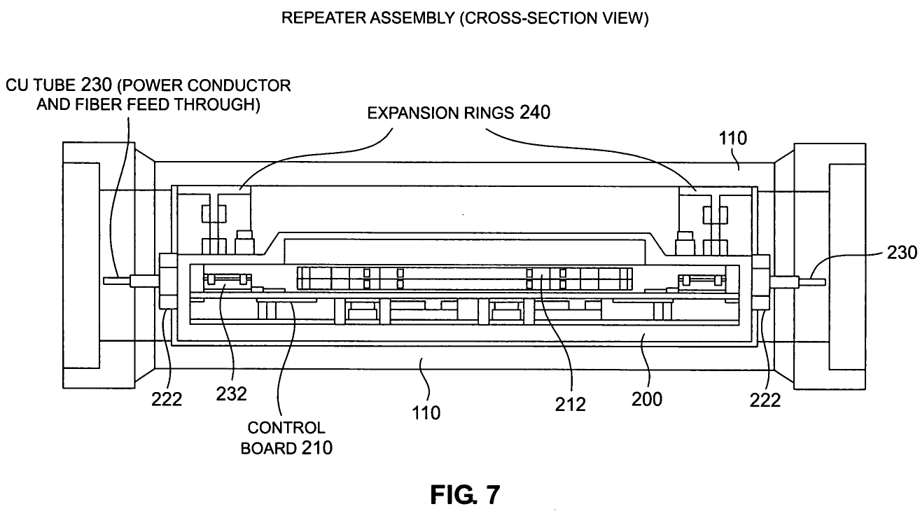

FIG. 2 shows the OAM 200 after its been assembled and sealed while FIG. 3 shows the OAM 200 as it is situated within the pressure housing 110. FIG. 7 shows a cross-sectional view through both the OAM 200 and the pressure housing 110 when the OAM 200 is properly situated within the pressure housing 110.

The exemplary embodiment of the OAM 200 depicted in the figures can support 4 erbium-doped fiber amplifiers (EDFAs), physically grouped as a dual amplifier unit for each of two fiber pairs. Each optical amplifier includes an erbium doped fiber, an optical pump source, an isolator and a gain flattening filter (GFF). The amplifiers are single-stage, forward pumped with cross-coupled pump lasers. A 3 dB coupler allows both coils of erbium doped fiber in the dual amplifier to be pumped if one of the two pump lasers fails. At the output, an isolator protects against backward-scattered light entering the amplifier. The gain flattening filter is designed to flatten the amplifier gain at the designed input power. An additional optical path may be provided to allow a filtered portion of the backscattered light in either fiber to be coupled back into the opposite direction, allowing for COTDR-type line-monitoring.

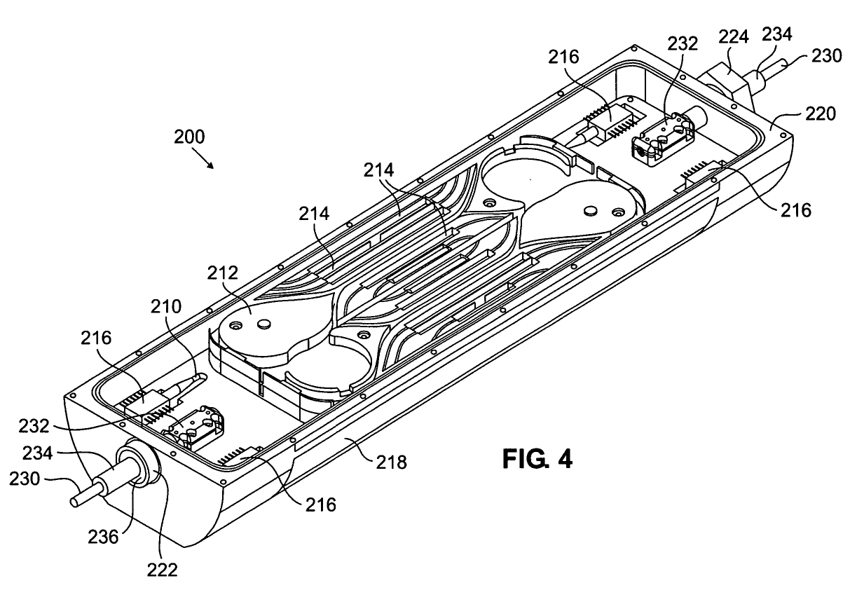

FIG. 4 shows the OAM 200 with its outer cover removed to expose the internal components located within a housing 218. As shown, a fiber tray 212 is located above a circuit board 210 that controls the EDFAs. The fiber tray 212 supports the various passive optical components of the EDFA and the excess fiber that interconnects them. The passive optical components (e.g., erbium doped fibers, couplers, isolators, and gain flattening filters) are located in slots 214 within the fiber tray 212. The active optical components 216 (e.g., the pump lasers) are mounted directly on the circuit board 210. The OAM housing 218 has a surface 220 that mates with the cover (shown in FIG. 2) to form a hermetic seal.

Optical cables for use in undersea optical telecommunication systems generally include a conductor such as a copper tube to provide electrical power to the amplifiers. Means must therefore be provided to convey the electrical power into OAM 200. In one embodiment of the invention the conductor tube itself penetrates directly into the OAM housing 218. Accordingly, access into the OAM 200 must be provided for both the conductor and the optical fibers. Such access is provided through ports 222 located on opposing ends of the OAM housing 218. The optical fibers (not shown in FIG. 4) extend within the conductor tube 230, which in turn is encased in a polyethylene sheath 234 to electrically insulate the conductor tube 230. The conductor tubes 230 extend to the splice bottles 112 seen in FIG. 1. The polyethylene sheath 234, conductor tube 230 and optical fibers extend directly into the OAM 200 through the ports 222. The conductor tube 230 terminates at a High Voltage (HV) terminal 232 located on the circuit board 210. The conductor tube 230 is physically connected to the HV terminal 232 to provide good electrical communication between them. The HV terminal 232 is configured as a terminal block with a large surface area that provides good mechanical retention of the conductor tube 230 and a low resistance electrical connection.

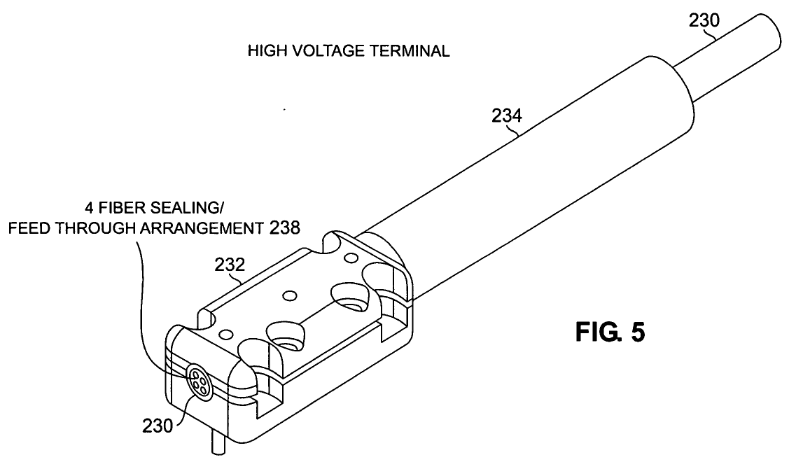

A polyethylene seal 236 is located in the ports 222 to provide a pressure seal between the polyethylene sheath 234 surrounding the conductor tube 230 and the OAM housing 218. Since polyethylene outgases and does not provide a good seal against hydrogen, additional sealing means must be provided to ensure that the OAM 200 is hermetically sealed. As best seen in FIG. 5, a ferrule 238 resides within the conductor tube 230 and provides a hermetic seal. The four optical fibers that enter the OAM 200 extend through the ferrule 238 and can be sealed to the ferrule with epoxy. As an additional measure to ensure a hermetic seal, the ends of the optical fibers that extend into the OAM 200 through the ferrule 238 may be provided with a metal coating or metallized jacket so that they can be soldered in place.

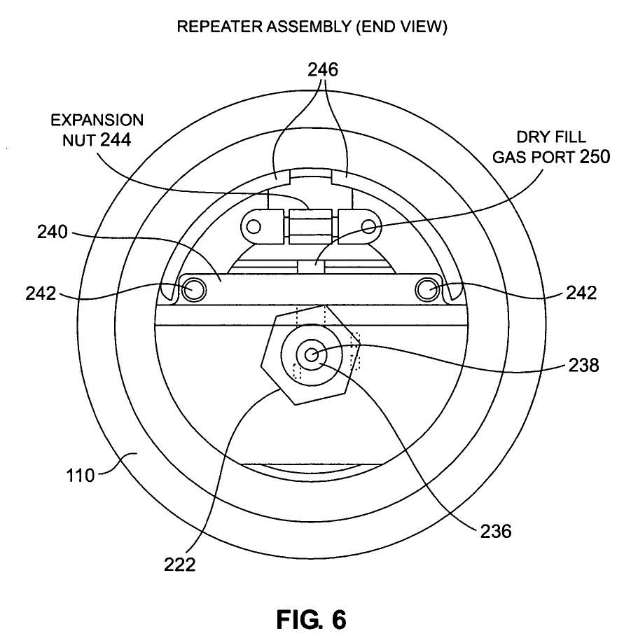

Returning to FIGS. 2 and 3, an expansion mechanism 240 resides on the outside of the OAM housing 218. The expansion mechanism 240 allows the OAM 200 to be inserted into pressure housings (e.g., pressure housing 110) of various dimensions. The expansion mechanism 240 can be expanded or retracted to the appropriate size to frictionally engage with the inner wall of the housing 218. The expansion mechanism 240 may be integrally formed with the OAM housing 218. As best seen in FIG. 6, the two portions 246 of the expansion mechanism 240 that contact the inner wall of the housing are supported by pivots 242. An expansion nut 244 drives threaded clevis pins outward into the two pivotable portions 246 of the expansion mechanism 240, thereby applying pressure to the inner wall of the pressure housing 110. One advantage of this expansion mechanism is that it is not required to satisfy the same tolerances that would otherwise be required if the OAM 200 were to engage the pressure housing 110 on its opposing ends. The particular expansion mechanism depicted in the figures provides infinite variability in indexing the OAM 200 with the pressure housing 110. That is, the OAM 200 can be rotated within the pressure housing 110 and locked into any desired position by the expansion mechanism 240. In other embodiments of the invention a positive alignment mechanism such as a boss, tab, tang or slot may be employed to provide a positive indexing means.

At the completion of the OAM 200 assembly process, but before the OAM 200 is integrated into the pressure vessel, the various hermetic seals are put in place and the interior of the OAM is filled with nitrogen gas via a fill port 250 that is visible in FIG. 6.

While the inventive module has been described in terms of an optical amplifier module, the invention more generally may be used to provide a hermetically sealed, functional unit that can be used not only for optical amplification, but for a wide variety of other undersea applications as well. For example, splices, filters, and surveillance sensors, or other electrically active components to which an optical signal is communicated may be located within the inventive module, which can subsequently be integrated into a pressure vessel that can withstand undersea environmental conditions.

1. In an external pressure vessel providing protection from external pressure in an undersea environment to a hermetically sealed optical amplifier module located therein, said hermetically sealed module comprising:
at least one optical amplifier;
an hermetically sealed housing for containing therein said at least one optical amplifier, said housing having a retaining element for retaining the housing within the external pressure vessel;
a plurality of ports for conveying into the housing, in an hermetically sealed manner, at least one optical fiber and a conductor incorporated in an undersea optical fiber cable, said conductor supplying electrical power to the optical amplifier; and
at least one conductive terminal located in the housing for establishing electrical contact with the conductor traversing each of the plurality of ports, said conductive terminal supplying electrical power from the conductor to said at least one optical amplifier.

2. The hermetically sealed module of claim 1 further comprising a pressure seal located between each of the ports and the conductor.

3. The hermetically sealed module of claim 2 wherein said pressure seal is a polyethylene seal.

4. The hermetically sealed module of claim 1 wherein said undersea optical fiber cable further comprises an electrically insulating sheath surrounding the optical fiber and the conductor, said pressure seal being located between the port and the electrically insulating sheath.

5. The hermetically sealed module of claim 1 wherein said conductive terminal includes a through hole traversed by said at least one optical fiber.

6. The hermetically sealed module of claim 5 further comprising a ferrule located in the through hole, said ferrule being traversed by said at least one optical fiber and providing a hermetic seal therewith.

7. The hermetically sealed module of claim 1 wherein an end portion of said at least one optical fiber includes a metallized coating for soldering said optical fiber within the housing.

8. The hermetically sealed module of claim 6 wherein an end portion of said at least one optical fiber includes a metallized coating for soldering said optical fiber within the housing.

9. The hermetically sealed module of claim 1 wherein said retaining element comprises an adjustable expansion mechanism located on an outer surface of the housing for exerting pressure against an inner wall of the pressure vessel so that the housing is retained therein.

10. The hermetically sealed module of claim 9 wherein said adjustable expansion mechanism includes a plurality of pivotable members.

11. The hermetically sealed module of claim 10 wherein said adjustable expansion mechanism includes an alignment member for aligning the housing within the pressure vessel.

12. The hermetically sealed module of claim 11 wherein said alignment member is selected from the group consisting of a boss, tab, tang and slot.

13. The hermetically sealed module of claim 11 wherein said adjustable expansion mechanism provides continuous indexing variability.

14. The hermetically sealed module of claim 1 further comprising a gas fill port extending into the housing for supplying gas to an interior of the housing.

15. The hermetically sealed module of claim 1 further comprising a fiber tray located in the housing for supporting optical fiber employed in the optical amplifier.

16. The hermetically sealed module of claim 1 further comprising a plurality of receptacles sized to receive a passive optical component employed in the optical amplifier.

17. The hermetically sealed module of claim 15 further comprising a plurality of receptacles sized to receive a passive optical component employed in the optical amplifier.

18. The hermetically sealed module of claim 17 wherein said plurality of receptacles are integrally formed with said fiber tray.

19. The hermetically sealed module of claim 1 wherein said optical amplifier includes a circuit board located in the housing.

20. The hermetically sealed module of claim 19 wherein said optical amplifier includes at least one optically active element mounted to the circuit board.

21. The hermetically sealed module of claim 20 wherein said at least one optical amplifier comprises a rare-earth doped optical amplifier.

22. The hermetically sealed module of claim 21 wherein said rare-earth doped optical amplifier includes a rare-earth doped fiber for imparting gain to an optical signal propagating therethrough, a pump source for supplying pump power to the rare-earth doped fiber, and a coupler for coupling the pump power to the rare-earth doped fiber, said rare-earth doped fiber and said coupler each residing in one of the plurality of receptacles.

23. The hermetically sealed module of claim 1 wherein said at least one optical amplifier comprises a plurality of optical amplifiers.

24. In an external pressure vessel providing protection from external pressure in an undersea environment to a hermetically sealed module located therein, said hermetically sealed module comprising:
an hermetically sealed housing for containing therein at least one electrical component to which an optical signal is communicated, said housing having a retaining element for retaining the housing within the external pressure vessel;
a plurality of ports for conveying into the housing, in an hermetically sealed manner, at least one optical fiber through which the optical signal is transmitted and a conductor incorporated in an undersea optical fiber cable, said conductor supplying electrical power to said at least one electrical component; and
at least one conductive terminal located in the housing for establishing electrical contact with the conductor traversing each of the plurality of ports.

25. The hermetically sealed module of claim 24 further comprising a pressure seal located between each of the ports and the conductor.

26. The hermetically sealed module of claim 25 wherein said pressure seal is a polyethylene seal.

27. The hermetically sealed module of claim 24 wherein said undersea optical fiber cable further comprises an electrically insulating sheath surrounding the optical fiber and the conductor, said pressure seal being located between the port and the electrically insulating sheath.

28. The hermetically sealed module of claim 24 wherein said conductive terminal includes a through hole traversed by said at least one optical fiber.

29. The hermetically sealed module of claim 28 further comprising a ferrule located in the through hole, said ferrule being traversed by said at least one optical fiber and providing a hermetic seal therewith.

30. The hermetically sealed module of claim 24 wherein an end portion of said at least one optical fiber includes a metallized coating for soldering said optical fiber within the housing.

31. The hermetically sealed module of claim 29 wherein an end portion of said at least one optical fiber includes a metallized coating for soldering said optical fiber within the housing.

32. The hermetically sealed module of claim 24 wherein said retaining element comprises an adjustable expansion mechanism located on an outer surface of the housing for exerting pressure against an inner wall of the pressure vessel so that the housing is retained therein.

33. The hermetically sealed module of claim 32 wherein said adjustable expansion mechanism includes a plurality of pivotable members.

34. The hermetically sealed module of claim 33 wherein said adjustable expansion mechanism includes an alignment member for aligning the housing within the pressure vessel.

35. The hermetically sealed module of claim 34 wherein said alignment member is selected from the group consisting of a boss, tab, tang and slot.

36. The hermetically sealed module of claim 34 wherein said adjustable expansion mechanism provides continuous indexing variability.

37. The hermetically sealed module of claim 24 further comprising a gas fill port extending into the housing for supplying gas to an interior of the housing.

38. The hermetically sealed module of claim 24 further comprising a fiber tray located in the housing for supporting optical fiber coupled to the electrical component.

39. The hermetically sealed module of claim 24 further comprising a plurality of receptacles sized to receive a passive component employed in the electrical component.

40. The hermetically sealed module of claim 38 further comprising a plurality of receptacles sized to receive a passive component employed in the electrical component.

41. The hermetically sealed module of claim 40 wherein said plurality of receptacles are integrally formed with said fiber tray.

42. The hermetically sealed module of claim 24 wherein said electrical component includes a circuit board located in the housing.

43. The hermetically sealed module of claim 42 wherein said electrical component includes at least one active element mounted to the circuit board.
